(19) United States
(12) Patent Application Publication
(10) Pub. No.: US 2007/0217793 A1
(43) Pub. Date: Sep. 20, 2007

(54) OPTICAL COMMUNICATION MODULE

(75) Inventor: Tomoharu HORIO, Kyoto (JP)

Correspondence Address: ROHM CO., LTD.;C/O KEATING & BENNETT, LLP, 8180 GREENSBORO DRIVE, SUITE 850, MCLEAN, VA, 22102, US

(73) Assignee: ROHM CO., LTD., Kyoto (JP)

(21) Appl. No.: 11/617,833

(22) Filed: Dec. 29, 2006

(30) Foreign Application Priority Data
Mar. 20, 2006 (JP) 2006-076597

(51) Int. Cl. H04B 10/00

(52) U.S. Cl. 398/164

(57) ABSTRACT

An infrared data communication module includes a substrate on which a wiring pattern including a pad member is disposed, a light emitting element bonded to the pad member, a light receiving element mounted on the substrate, an integrated circuit element for controlling driving of the light emitting element and the light receiving element, a protective resin member for shielding the light emitting element, and a resin package for shielding the light emitting element, the light receiving element, and the integrated circuit element. The infrared data communication module further includes an annular resin film for inwardly surrounding the light emitting element in a planar direction of the substrate. The resin film includes an outer peripheral end and an inner peripheral end. An outer peripheral end of the protective resin member coincides with the outer peripheral end of the resin film, or is formed at a position closer to the light emitting element than the outer peripheral end of the resin film. The optical communication module is capable of properly protecting a light emitting element.

### BACKGROUND OF THE INVENTION

1. Field of the Invention

The present invention relates to an optical communication module for use in two-way communication in an electronic device.

2. Description of the Related Art

Optical communication modules provided with a light emitting element and a light receiving element are used for two-way communication in electronic devices such as laptop computers, mobile phones, and personal digital assistants (PDAs). The optical communication modules include, for instance, infrared data communication modules in accordance with the IrDA (Infrared Data Association) specifications.

FIG. 7 shows an example of a conventional infrared data communication module (see, e.g., Japanese Unexamined Patent Publication No. 2002-324916). The infrared data communication module X in FIG. 7 includes a light emitting element 93, a light receiving element 94, and an integrated circuit element 95, which are mounted on a substrate 91, and a resin package 97. A wiring pattern 92 including a metallic film is formed on the substrate 91. The light emitting element 93 is die-bonded to a pad member 92a, which is a part of the wiring pattern 92. The light emitting element 93 is configured to emit infrared light. The light receiving element 94 is configured to generate photovoltaic power in accordance with the amount of the infrared light received on a light receiving surface 94a of the light receiving element 94.

The light emitting element 93 including the pad member 92a, and the light receiving surface 94a of the light receiving element 94 are respectively shielded by protective resin members 96. The protective resin members 96 each include a so-called JCR (Junction Coating Resin), and are made of, e.g., a silicone resin material. The protective resin members 96 are adapted to protect the light emitting element 92 and the light receiving element 94 by reducing stresses exerted thereto. The resin package 97 is formed with two lens portions 97a and 97b at positions opposed to the light emitting element 93 and the light receiving element 94, respectively. Infrared light emitted from the light emitting element 93 is projected onto the lens portion 97a where a directional characteristic of the infrared light is enhanced. The infrared light which is directed upwardly in FIG. 7 is condensed on the lens portion 97b and directed toward the light receiving element 94. In this way, two-way communication using infrared light is conducted by the infrared data communication module X.

In forming the protective resin member 96 for shielding the light emitting element 93, a liquid silicone resin material for forming the protective resin member 96 may likely spread over a wide area on the substrate 1. In particular, if the substrate 1 is made of a glass epoxy resin material, the silicone resin material is highly likely to spread over a wide area on the substrate 1 because of its high fluidity. If the protective resin member 96 flattens due to the spread of the silicone resin material, the light emitting element 93 may be exposed from the protective resin member 96, which may make it difficult or impossible to properly protect the light emitting element 93.

### SUMMARY OF THE INVENTION

In order to overcome the problems described above, preferred embodiments of the present invention provide an optical communication module that reliably protects a light emitting element.

A first preferred embodiment of the present invention is directed to an optical communication module including a substrate on which a wiring pattern including a pad member is disposed; a light emitting element bonded to the pad member; a light receiving element mounted on the substrate; an integrated circuit element arranged to control driving of the light emitting element and the light receiving element; a protective resin or plastic member (hereinafter, simply referred to as resin) arranged to shield the light emitting element; a resin or plastic package (hereinafter, simply referred to as resin) arranged to shield the light emitting element, the light receiving element, and the integrated circuit element; and an annular resin or plastic film (hereinafter, simply referred to hereinafter as resin) for inwardly surrounding the light emitting element in a planar direction of the substrate. The resin film includes an outer peripheral end and an inner peripheral end. An outer peripheral end of the protective resin member coincides with the outer peripheral end of the resin film, or is arranged at a position closer to the light emitting element than the outer peripheral end of the resin film.

The above-described arrangement prevents the protective resin member from unduly and undesirably spreading over the substrate. With this arrangement, the protective resin member can be formed into, e.g., a substantially hemi-spherical shape with a height sufficiently higher than the light emitting element, thereby completely shielding the light emitting element. This is advantageous for reliably protecting the light emitting element.

Preferably, the inner peripheral end of the resin film may be arranged at a position closer to the light emitting element than an outer peripheral end of the pad member. This arrangement prevents the protective resin member from contacting the substrate. Accordingly, in the case where the protective resin member is made of, e.g., a liquid resin material, there is no likelihood that the resin material may spread over a wide area on the substrate.

Preferably, the outer peripheral end of the resin film may be arranged at a position closer to the light emitting element than the outer peripheral end of the pad member. With this arrangement, even if the liquid resin material for forming the protective resin member is inadvertently applied to an outer area of the resin film by an application failure or a like operation, the outer peripheral end of the pad member serves as a member for blocking the spreading of the resin material.

Preferably, the resin film may be made of a resist material. This is advantageous in forming the resin film into an accurate shape by a light exposure process using a mask, for example.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view of an optical communication module according to a first preferred embodiment of the present invention.

FIG. 2 is a plan view showing essential elements of the optical communication module according to the first preferred embodiment of the present invention.

FIG. 3 is an enlarged cross-sectional view showing essential elements of the optical communication module according to the first preferred embodiment of the present invention.

FIG. 4 is an enlarged plan view showing essential elements of the optical communication module according to the first preferred embodiment of the present invention.

FIG. 5 is an enlarged cross-sectional view showing essential elements of a modified optical communication module in the first preferred embodiment of the present invention.

FIG. 6 is an enlarged cross-sectional view showing essential elements of an optical communication module according to a second preferred embodiment of the present invention.

FIG. 7 is a cross-sectional view showing an example of a conventional optical communication module.

### DETAILED DESCRIPTION OF PREFERRED EMBODIMENTS

In the following, preferred embodiments of the invention are described referring to the drawings.

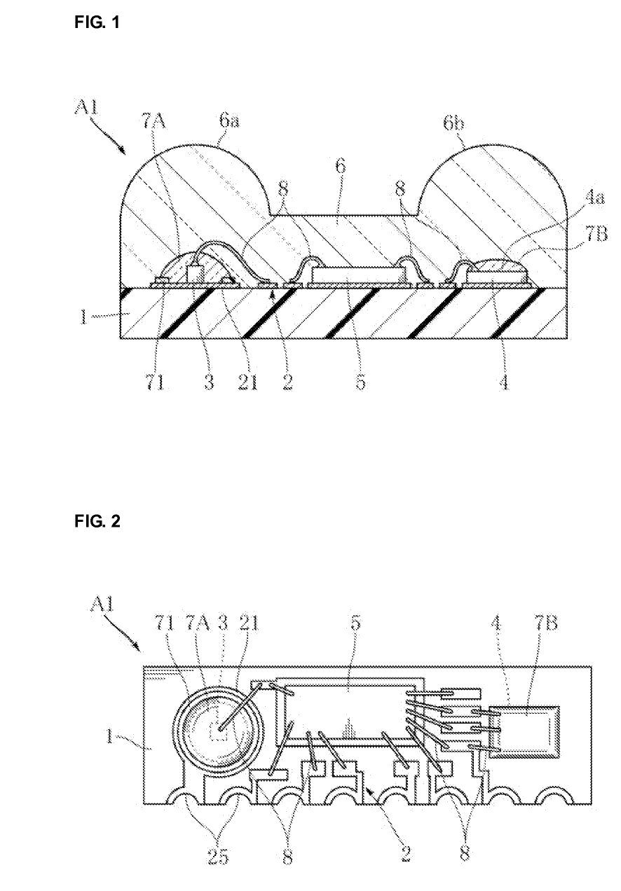

FIGS. 1 through 4 are diagrams showing an optical communication module according to a first preferred embodiment of the present invention. An infrared data communication module A1 according to the first preferred embodiment preferably includes a substrate 1, a light emitting element 3, a light receiving element 4, a driving IC 5, and a resin package 6. The infrared data communication module A1 is configured to perform two-way communications using infrared light in accordance with the IrDA (Infrared Data Association) specifications.

The substrate 1 is preferably made of, e.g., a glass epoxy resin material, and preferably has a substantially rectangular shape in plan view as a whole. A wiring pattern 2 is formed on the substrate 1. The wiring pattern 2 is produced by forming a pattern on a thin film made of, e.g., Cu. The wiring pattern 2 has a pad member 21. The pad member 21 is a component for mounting the light emitting element 3 thereon. As shown in FIG. 2, terminals 25 are provided on a side portion of the substrate 1. The terminals 25 are used to mount the infrared data communication module A1 on a circuit board or a like device by plane-mounting. The terminals 25 include a metallic film for shielding recessed grooves formed in the side portion of the substrate 1.

The light emitting element 3 includes, e.g., an infrared light emitting diode capable of emitting infrared light. The light emitting element 3 is die-bonded to the pad member 21 by, e.g., a conductive adhesive. The light emitting element 3 is connected to the wiring pattern 2 by a wire 8. The light emitting element 3 has its entirety shielded by a protective resin member 7A.

The light receiving element 4 includes, e.g., a PIN photodiode capable of detecting infrared light. The light receiving element 4 is connected to the wiring pattern 2 by a wire 8. The light receiving element 4 is configured to generate photovoltaic power in accordance with the amount of infrared light received on a light receiving surface 4a thereof shown in FIG. 1 upon receiving the infrared light. The light receiving surface 4a is shielded by a protective resin member 7B.

The driving IC 5 is adapted to control light emitting and receiving operations of the light emitting element 3 and the light receiving element 4. The driving IC 5 is connected to the wiring pattern 2 by wires 8, and is also connected to the light emitting element 3 and to the light receiving element 4 by way of the wiring pattern 2.

The protective resin members 7A and 7B each preferably include a so-called JCR, and are preferably made of a silicone resin material capable of transmitting, e.g., infrared light. The protective resin members 7A and 7B have a function of minimizing the application of an unduly large stress to the light emitting element 3 and to the light receiving element 4. In particular, the protective resin members 7A and 7B are advantageous in preventing detachment of the light emitting element 3 and the light receiving element 4, as well as detachment of joint portions of the light emitting element 3 and the light receiving element 4 with the wires 8 connected thereto, from the substrate 1. The protective resin members 7A and 7B also prevent erroneous communication of the light emitting element 3 and the light receiving element 4 with a part of the wiring pattern 2 or a like part.

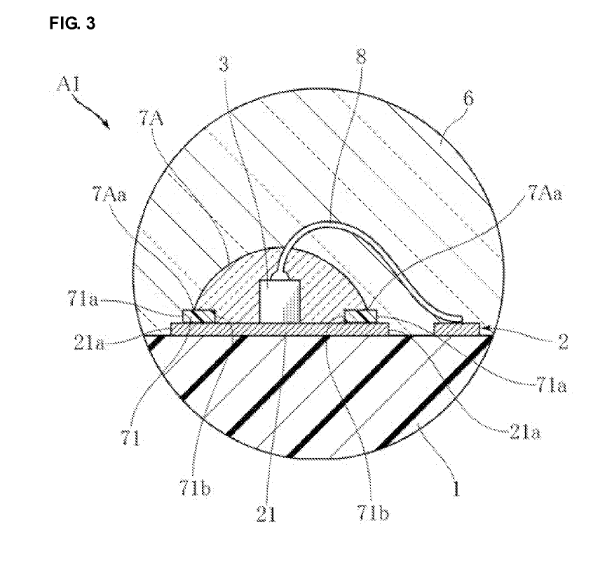

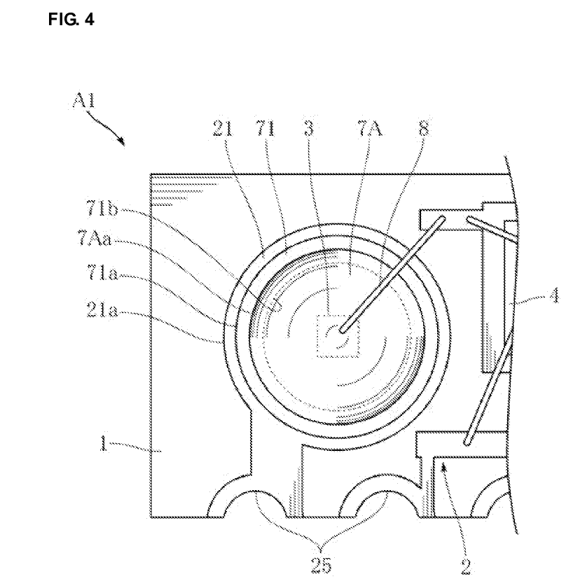

As shown in FIGS. 3 and 4, the protective resin member 7A has a substantially hemi-spherical shape to shield the light emitting element 3. The light emitting element 3 and the protective resin member 7A are surrounded by a resin film 71. The resin film 71 is preferably made of, e.g., a resist material, and has an annular shape in plan view. The resin film 71 is provided on the pad member 21, and has an outer peripheral end 71a at a position closer to the light emitting element 3 than an outer peripheral end 21a of the pad member 21. The resin film 71 also has an inner peripheral end 71b at a position closer to the light emitting element 3 than an outer peripheral end 7Aa of the protective resin member 7A. In other words, the annular resin film 71 surrounds the protective resin member 7A at an outer position.

The protective resin member 7A is produced by, after forming the resin film 71 on the pad member 21, applying a liquid silicone resin material dropwise onto an area surrounded by the resin film 71. The resist material for forming the resin film 71 has a property that the resist material is modified by light exposure. Accordingly, the resist material is a material suitable for patterning, utilizing the light exposure property. Examples of the resist material are PVA (polyvinyl alcohol), which is a negative resist material that is insoluble in a developer by light exposure, PMMA (polymethylmethacrylate), which is a positive resist material that is soluble in a developer by light exposure, and novolac resins.

The resin package 6 is preferably made of, e.g., an epoxy resin material containing a pigment, and has a property capable of blocking visible light and a property capable of transmitting infrared light. The resin package 6 is produced by a transfer molding method or a like method, and is mounted on the substrate 1 so as to shield the light emitting element 3, the light receiving element 4, and the driving IC 5. As shown in FIG. 1, the resin package 6 is integrally formed with two lens portions 6a and 6b. The lens portion 6a is arranged opposed to the light emitting element 3 so that the lens portion 6a projects infrared light emitted from the light emitting element 3, with a directional characteristic of the infrared light being enhanced. The lens portion 6b is arranged opposed to the light receiving element 4 so that the lens portion 6b condenses the infrared light received by the infrared data communication module 1A for output onto the light receiving surface 4a of the light receiving element 4.

Next, an operation of the infrared data communication module 1A is described.

In the above preferred embodiment, the flow of the liquid silicone resin material for forming the protective resin member 7A is blocked by the outer peripheral end 71a of the protective film 71 when forming the protective resin member 7A. This prevents the likelihood that the liquid silicone resin material may spread over a wide area on the substrate 1, which enables to completely shield the light emitting element 3 by the protective resin member 7A. The silicone resin material for forming the protective resin member 7A is considerably softer than the epoxy resin material for forming the resin package 6. Accordingly, this arrangement is advantageous in preventing the likelihood that an unduly large stress may be applied to the light emitting element 3 when forming the resin package 6 by thermosetting or a like operation.

Also, the silicone resin material for forming the protective resin member 7A has smaller adhesion relative to the epoxy resin material for forming the resin package 6. Furthermore, it is well known that heat generated in thermosetting the resin package 6 causes dispersion of the silicone resin component of the protective resin member 7A over the resin package 6. The dispersion may further lower the adhesion of the protective resin member 7A to the resin package 6. In the present preferred embodiment, the size of the protective resin member 7A can be made smaller, as compared with the conventional arrangement. The protective resin member 7A having a smaller size results in an increase in the adhesion of the resin package 6 to the substrate 1, which is advantageous in preventing detachment of the resin package 6 from the substrate 1.

Further, since the inner peripheral end 71b of the resin film 71 is arranged at a position closer to the light emitting element 3 than the outer peripheral end 21a of the pad member 21, the outer peripheral end 7Aa of the protective resin member 7A can be located at least on the pad member 21. In other words, there is no likelihood that a portion of the protective resin member 7A may be brought into direct contact with the substrate 1. As mentioned above, the liquid silicone resin material has a relatively large fluidity. However, since there is no likelihood that the liquid silicone resin material may contact the substrate 1, the arrangement is advantageous in preventing the likelihood that the liquid silicone resin material may unduly spread over the substrate 1.

Furthermore, since the outer peripheral end 71a of the resin film 71 is formed at a position closer to the light emitting element 3 than the outer peripheral end 21a of the pad member 21, the outer peripheral end 21a of the pad member 21 is exposed from the resin film 71. With this arrangement, when forming the protective resin member 7A, the outer peripheral end 21a of the pad member 21, in addition to the outer peripheral end 71a of the protective film 71 serves as a member for blocking the spread of the liquid silicone resin material. For instance, even if the liquid silicone resin material spreads on an outer area of the resin film 71 by application of the liquid silicone resin material with an amount larger than a predetermined amount due to an application failure, the outer peripheral end 21a of the pad member 21 serves as the member for blocking the spread of the liquid silicone resin material.

Use of the resist material as the material for the resin film 71 is advantageous in forming the resin film 71 into an accurate shape by a light exposure process using a mask. This is advantageous in restricting the spread of the liquid silicone resin material when applying the protective resin member 7A to a peripheral area around the light emitting element 3.

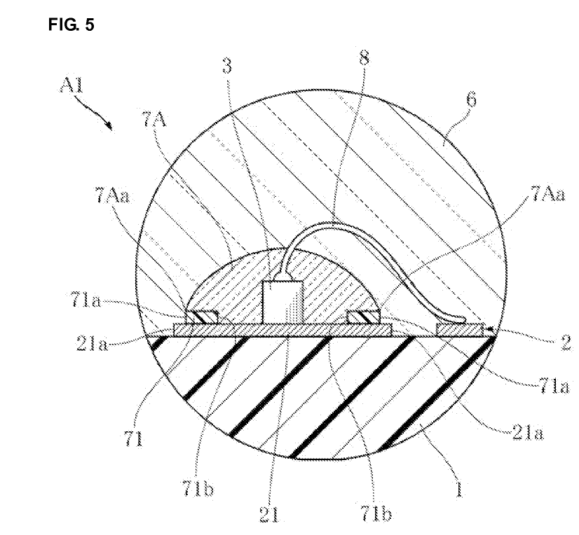

In the infrared data communication module A1 shown in FIGS. 1 through 4, the outer peripheral end 7Aa of the protective resin member 7A is formed at a position closer to the light emitting element 3 than the outer peripheral end 71a of the resin film 71. Alternatively, the optical communication module according to another preferred embodiment may have a construction as shown in FIG. 5. FIG. 5 shows a modified infrared data communication module A1. In the modification, an outer peripheral end 7Aa of a protective resin member 7A coincides with an outer peripheral end 71a of a resin film 71. The modified infrared data communication module A1 preferably has substantially the same operation as the foregoing preferred embodiment. Further alternatively, a portion of the outer peripheral end 7Aa of the protective resin member 7Aa may be formed at a position coincident with the outer peripheral end 71a of the resin film 71, and the remaining portion of the outer peripheral end 7Aa of the protective resin member 7Aa may be formed at a position closer to the light emitting element 3 than the outer peripheral end 71a of the resin film 71.

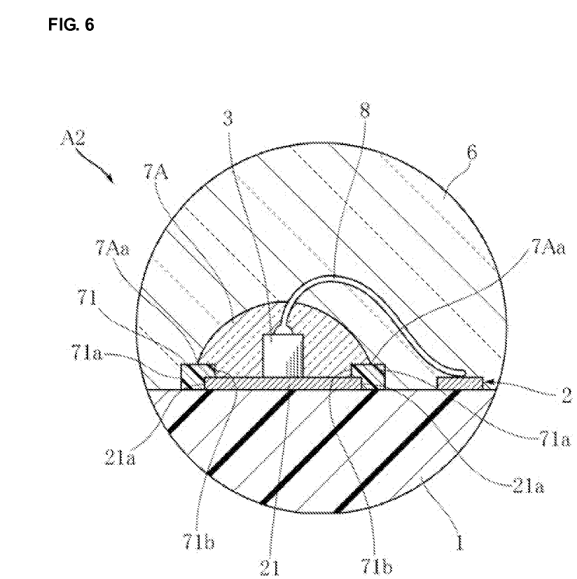

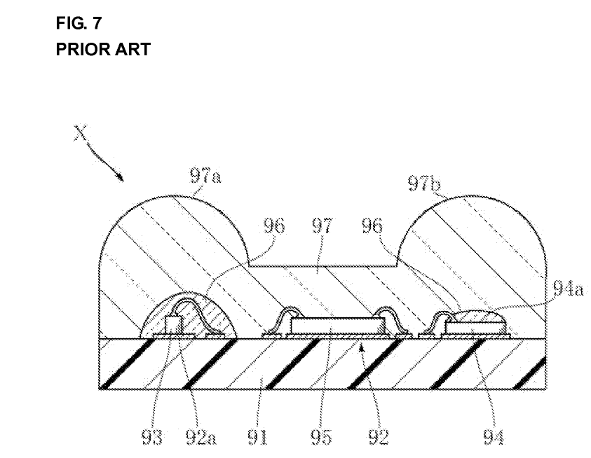

FIG. 6 is a diagram showing an optical communication module according to a second preferred embodiment of the present invention. In FIG. 6, elements identical or equivalent to those in the first preferred embodiment are denoted by the same reference numerals as in the first preferred embodiment. An infrared data communication module A2 shown in FIG. 6 is different from the infrared data communication module A1 in the first preferred embodiment in the position where the resin film 71 is formed. In the second preferred embodiment, an outer peripheral end 71a of the resin film 71 is formed at a position farther away from a light emitting element 3 than an outer peripheral end 21a of a pad member 21.

Similarly to the first preferred embodiment, the second preferred embodiment is advantageous in preventing the overspreading of the liquid silicone resin material when forming the protective resin member 7A. In the second preferred embodiment, although a blocking effect by the outer peripheral end 21a of the pad member 21 with respect to the spread of the liquid silicone resin material cannot be expected, the outer peripheral end 21a of the pad member 21 is shielded by the resin film 71. This is advantageous in preventing detachment of the pad member 21 from the substrate 1 due to thermal distortion in forming the resin package 6 by thermosetting.

The optical communication module according to the present invention is not limited to the foregoing preferred embodiments. Specific constructions of the respective elements defining the inventive optical communication module may be arbitrarily modified in various ways.

The resist material is preferred as the material for the resin film. Alternatively, any material suitable for forming the resin film into an annular film may be used. The material for the protective resin member is not limited to the silicone resin material, but a material suitable for exhibiting a function as a JCR may be used.

The light emitting element and the light receiving element are not limited to the devices capable of emitting or receiving infrared light, but may include devices capable of emitting or receiving light of various wavelengths including visible light. In other words, the inventive optical communication module is not limited to the infrared data communication module, but may include a communication system using, e.g., visible light.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. An optical communication module comprising:
a substrate having a wiring pattern and a pad member;
a light emitting element bonded to the pad member;
a light receiving element mounted on the substrate;
an integrated circuit element arranged to control driving of the light emitting element and the light receiving element;
a protective member arranged to shield the light emitting element;
a package arranged to shield the light emitting element, the light receiving element, and the integrated circuit element; and
an annular film arranged to surround the light emitting element in a planar direction of the substrate, the annular film including an outer peripheral end and an inner peripheral end; wherein
an outer peripheral end of the protective member coincides with the outer peripheral end of the annular film, or is arranged at a position closer to the light emitting element than the outer peripheral end of the annular film.

2. The optical communication module according to claim 1, wherein the inner peripheral end of the annular film is arranged at a position closer to the light emitting element than an outer peripheral end of the pad member.

3. The optical communication module according to claim 2, wherein the outer peripheral end of the annular film is arranged at a position closer to the light emitting element than the outer peripheral end of the pad member.

4. The optical communication module according to claim 1, wherein the annular film is made of a resist material.

5. The optical communication module according to claim 1, wherein the protective member, the package, and the annular film are made of a resin.

6. The optical communication module according to claim 1, wherein the annular film is arranged entirely on a top surface of the pad member.

7. The optical communication module according to claim 2, wherein the outer peripheral end of the annular film is arranged at a position farther away from the light emitting element than the outer peripheral end of the pad member.
